(19) United States
(12) Patent Application Publication
(10) Pub. No.: US 2010/0150387 A1
(43) Pub. Date: Jun. 17, 2010

(54) SYSTEM AND METHOD FOR PROVIDING HEARING ASSISTANCE TO A USER

(75) Inventors: Evert Dijkstra, Fontaines (CH); Martin Luetzen, Waiblingen (DE); Dirk Fromme, Koeln (DE)

Correspondence Address: ROBERTS MLOTKOWSKI SAFRAN & COLE, P.C.;Intellectual Property Department, P.O. Box 10064, MCLEAN, VA, 22102-8064, US

(73) Assignee: PHONAK AG, Staefa (CH)

(21) Appl. No.: 12/522,523

(22) PCT Filed: Jan. 10, 2007
(86) PCT No.: PCT/EP07/00177

§ 371 Date: Mar. 2, 2010

(51) Int. Cl. H04R 25/00

(52) U.S. Cl. 381/315; 381/317

(57) ABSTRACT

A system for providing hearing assistance to a user having an audio signal source, a transmission unit for transmitting audio signals from the audio signal source via a wireless right ear audio link to a right ear unit having a receiver unit and a device for stimulating the user's right ear according to the audio signals received from the transmission unit and via a wireless left ear audio link to a left ear unit having a receiver unit and means for stimulating the user's left ear according to the audio signals received from the transmission unit, and a device for delaying the stimulation of one of the user's ears with the audio signals received from the transmission unit relative to the stimulation of the other one of the user's ears with the audio signals received from the transmission unit by 1 msec to 10 msec.

### BACKGROUND OF THE INVENTION

1. Field of the Invention

The present invention relates to a system and a method for providing hearing assistance to a user wherein audio signals from an audio signal source, which usually is a microphone arrangement, are transmitted by a transmission unit via a wireless audio link to a right ear unit and a left ear unit which are worn at or at least in part in the user's right ear and left ear, respectively, and which comprise means for stimulating the respective user's ear according to the transmitted audio signals.

2. Description of Related Art

Usually in such systems the wireless audio link is an FM radio link. The benefit of such systems is that sound captured by a remote microphone at the transmission unit can be presented at a proper sound pressure level to the hearing of the user wearing the receiver unit at the user's ear(s) without being effected by background noise, reverberations and distance issues.

According to one typical application of such wireless audio systems, the stimulating means is a loudspeaker which is part of the receiver unit or is connected thereto. Such systems are particularly helpful for being used in teaching normal-hearing children suffering from auditory processing disorders (APD), Attention Deficit or Hyperactivity Disorders (ADHD) or Learning Disabilities, wherein the teacher's voice is captured by the microphone of the transmission unit, and the corresponding audio signals are transmitted to and are reproduced by the receiver unit worn by the child, so that the teacher's voice can be heard by the child at an enhanced level, in particular, with respect to the background noise level and reverberations prevailing in the classroom. It is well known that presentation of the teacher's voice at such enhanced level supports the child in listening to the teacher. Such systems also may be used by all hearing impaired or normal-hearing students with understanding problems in noisy situations or situations with background speech.

According to another typical application of wireless audio systems, the receiver unit is connected to or integrated into a hearing instrument, such as a hearing aid. The benefit of such systems is that the microphone of the hearing instrument can be supplemented or replaced by the remote microphone which produces audio signals which are transmitted wirelessly to the FM receiver and thus to the hearing instrument. In particular, FM systems have been standard equipment for children with hearing loss in educational settings for many years. Their merit lies in the fact that a microphone placed a few inches from the mouth of a person speaking receives speech from that person at a much higher level than one placed several feet away at the ear of a listener. This increase in speech level corresponds to an increase in signal-to-noise ratio (SNR) due to the direct wireless connection to the listener's amplification system. The resulting improvements of signal level and SNR in the listener's ear are recognized as the primary benefits of FM radio systems, as hearing-impaired individuals are at a significant disadvantage when processing signals with a poor acoustical SNR.

Most FM systems in use today provide two or three different operating modes. The choices are to get the sound from: (1) the hearing instrument microphone alone, (2) the FM microphone alone, or (3) a combination of FM and hearing instrument microphones together.

Usually, most of the time, the FM system is used in mode (3), i.e., the FM plus hearing instrument combination (often labeled “FM+M” or “FM+ENV” mode). This operating mode allows the listener to perceive the speaker's voice from the remote microphone with a good SNR while the integrated hearing instrument microphone allows the listener to also hear environmental sounds. This allows the user/listener to hear and monitor his own voice, as well as voices of other people or environmental noise, as long as the loudness balance between the FM signal and the signal coming from the hearing instrument microphone is properly adjusted. The so-called “FM advantage” measures the relative loudness of signals when both the FM signal and the hearing instrument microphone are active at the same time. As defined by the ASHA (American Speech-Language-Hearing Association 2002), FM advantage compares the levels of the FM signal and the local microphone signal when the speaker and the user of an FM system are spaced by a distance of two meters. In this example, the voice of the speaker will travel 30 cm to the input of the FM microphone at a level of approximately 80 dB-SPL, whereas only about 65 dB-SPL will remain of this original signal after traveling the 2 m distance to the microphone in the hearing instrument. The ASHA guidelines recommend that the FM signal should have a level 10 dB higher than the level of the hearing instrument's microphone signal at the output of the user's hearing instrument.

When following the ASHA guidelines (or any similar recommendation), the relative gain, i.e., the ratio of the gain applied to the audio signals produced by the FM microphone and the gain applied to the audio signals produced by the hearing instrument microphone, has to be set to a fixed value in order to achieve, e.g., the recommended FM advantage of 10 dB under the above-mentioned specific conditions.

An example of an FM system allowing to vary the FM advantage according to the present auditory scene in order to optimize the SNR at any time is known from European Patent Application EP 1 691 574 A1.

Other known measures for increasing the intelligibility of speech are the use of at least two spaced apart microphones for achieving acoustic beam-forming in order to enhance the desired speech signals over the undesired background noise, the use of audio signal processing algorithms for separating speech signals from background noise, such as blind source separation (BSS), and the automatic selection of one of a plurality of hearing aid programs depending on a classification of the present auditory scene in order to optimize the parameters of the audio signal processing in the hearing aid according to the present auditory scene.

From U.S. Patent Application Publication 2006/0093172 A1, a radio transmission system is known wherein audio signals captured by a remote microphone are transmitted to the radio receivers of two hearing aids, with the phase of the audio signal received by the radio receiver of one of the hearing aids being inverted in order to improve the perceived SNR in order to improve speech intelligibility.

According to an article by H. Levitt and L. R. Rabiner “Binaural Release from Masking for Speech and Gain in Intelligibility”, The Journal of the Acoustical Society of America, 1967, the intelligibility of speech signals presented binaurally to a test person, with narrow-band Gaussian masking noise being presented at the same time to both ears of the test person in an identical manner, was improved if the binaural speech signal is delayed by 0.5 msec to 10 msec at one of the ears. A perceived SNR improvement of 13 dB was achieved for single words.

Such tests exploit a psychoacoustic phenomenon known as the binaural masking level difference (BMLD). The BMLD is evaluated where tones are presented to both ears at the same time that a masking or competing noise is being delivered binaurally. A different type of measurement is known as the binaural intelligibility level difference (BILD). This test is based on the fact that the recognition of speech can be measured by presenting nonsense, one-syllable words, denoted logatomes, to a test person at varying sound pressure levels to determine the degree of syllabic recognition. This is measured as the percentage of syllables in a spoken sentence that are perceived correctly. The syllabic intelligibility level is defined as the sound pressure of speech in connection with which a given degree, for example, 50%, of syllabic intellegibility is attained (see Blauert et al., Spatial Hearing, The MIT Press, 1974). The measurements of Levitt and Rabiner, 1967, show an essentially constant BMLD of about 13 dB and an essentially constant BILD of about 3 dB for an interaural time delay of 0.5 msec to about 10 msec.

### SUMMARY OF THE INVENTION

It is an object of the invention to provide for a hearing assistance system wherein audio signals from a remote audio signal source are provided wirelessly to both ears of the user and wherein speech intelligibility should be further enhanced. It is a further object of the invention to provide for a corresponding method of providing hearing assistance to a user.

According to the invention these objects are achieved by a system and a method as described herein. The invention is beneficial in that, by delaying the stimulation of one of the user's ear with the audio signals received from the transmission unit relative to the stimulation of the other one of the user's ears with the audio signals received from the transmission unit by 1 msec to 10 msec, speech intelligibility can be enhanced in situations where background noise is present at the user's ears in addition to the audio signals received from the transmission unit. The invention is particularly beneficial if the background noise is identical at both ears. However, a benefit is also obtained if also the background noise is delayed at one of the ears together with the audio signal from the transmission unit, as long as the background is uncorrelated.

These and further objects, features and advantages of the present invention will become apparent from the following description when taken in connection with the accompanying drawings which, for purposes of illustration only, show several embodiments in accordance with the present invention.

### BRIEF DESCRIPTION OF THE DRAWINGS

FIG. 1 is a schematic view of the use of a hearing assistance system according to the invention;

FIG. 2 is a block diagram of a first embodiment of a hearing assistance system according to the invention;

FIG. 3 is a block diagram of a second embodiment of a hearing assistance system according to the invention;

FIG. 4 is a block diagram of a third embodiment of a hearing assistance system according to the invention;

FIG. 5 is an example of an audio signal presented to the user's right ear and left ear, respectively; and

FIG. 6 is a schematic representation of the results of BILD measurements for various values of monaural time delay of speech signals in binaural noise.

### DETAILED DESCRIPTION OF THE INVENTION

The invention is based on the acoustic phenomenon of binaural interaction of the auditory system, which is affected both by interaural time differences (ITD) and interaural level differences (ILD). Due to the physical properties of frequency/wave length of acoustic signals, the sensitivity of the auditory system to ITD and ILD depends on the frequency. For example, at low frequencies (around 500 Hz) the auditory system is more responsive to changes of the ITD, whereas at high frequencies (above 1500 Hz) the auditory system is more sensitive to changes of the ILD. For complex signals like speech or music both ITD and ILD play a role. A change in one or both of ITD (predominant at low frequencies) and ILD (predominant at high frequencies) is detected and results in improved signal intelligibility. If the time of arrival of the sound signal at one of the ears is delayed relative to the other one of the ears, signal detection by the auditory system is facilitated and the signal consequently can be perceived more clearly due to this signal delay between the two ears.

As already mentioned above, this effect has been mentioned by Levitt and Rabiner in 1967. The inventors of the present invention have conducted experiments in order to investigate whether this effect could be exploited for hearing assistance systems. In these experiments, a speech signal was presented to a test person via a headset, which was masked by white noise. Both the speech signal and the noise signal were presented as stereo signals. The speech signals were selected according to the “Oldenburg sentence recognition test” (see, e.g., Wagener, K., Kühnel, V., Kollmeier, B., 2001, “Entwicklung and Evaluation eines Satztests für die deutsche Sprache, Teil 1: Design des Oldenburger Satztests” Z. für Audiologie, 1: 4-15, 2001). During the tests for a given time delay Δt of the speech signal between the two ears, the level of the speech signal relative to level of the noise signal was changed step-wise in order to determine the volume level at which the speech reception threshold was 50% (i.e., the level at which 50% of the test words were correctly understood by the test person). The measurements were carried-out with various test persons for various values of the time delay Δt.

In FIG. 6, an example of test results is shown, wherein the measured SNR for the speech reception threshold of 50% is shown for white noise for a time delay Δt of 3 msec, 5 msec and 7 msec, no time delay and no time delay but a phase shift of 180° between the left ear and right ear (see left part of FIG. 6), with, in addition, corresponding measurements for another type of noise (“Icra8 noise”) for no time delay and for a time delay of 7 msec being shown for comparison (see, right part of FIG. 6). Icra8 noise is synthetic generated noise which is very close to real life situations noise. The measurements represent the mean for five test persons.

For white noise the SNR for 3 msec, 5 msec and 7 msec time delay was enhanced by 4.7 dB, 5.8 dB and 8.4 dB, respectively, with regard to the case without time delay. The phase shift of 180° resulted in an enhancement of the SNR of 3.7 dB. Also for Icra8 noise an enhanced SNR was obtained with a delayed signal of 7 msec.

Consequently, speech recognition in noise can be significantly enhanced by introducing a time difference of a few milliseconds for presentation of a speech signal to the right ear and the left ear, respectively. The best results can be achieved if the noise signal is identical at both ears. However, an improvement of the speech recognition is also possible if both the speech signal and the noise are subject to the monaural time delay if the noise is uncorrelated.

A second effect of a time difference between the right ear signal and the left ear signal is known as the “Haas-effect” according to which the signal which arrives first generates a virtual hearing direction. This effect might result in confusion by the perceived acoustic impressions in situations in which the position of the speaker is not known. However, for the usual applications of the invention, the user of the hearing assistance system usually will be able to see the speaker (i.e., the person who is using the microphones of the transmission unit), so that the “Haas-effect” usually will not be critical.

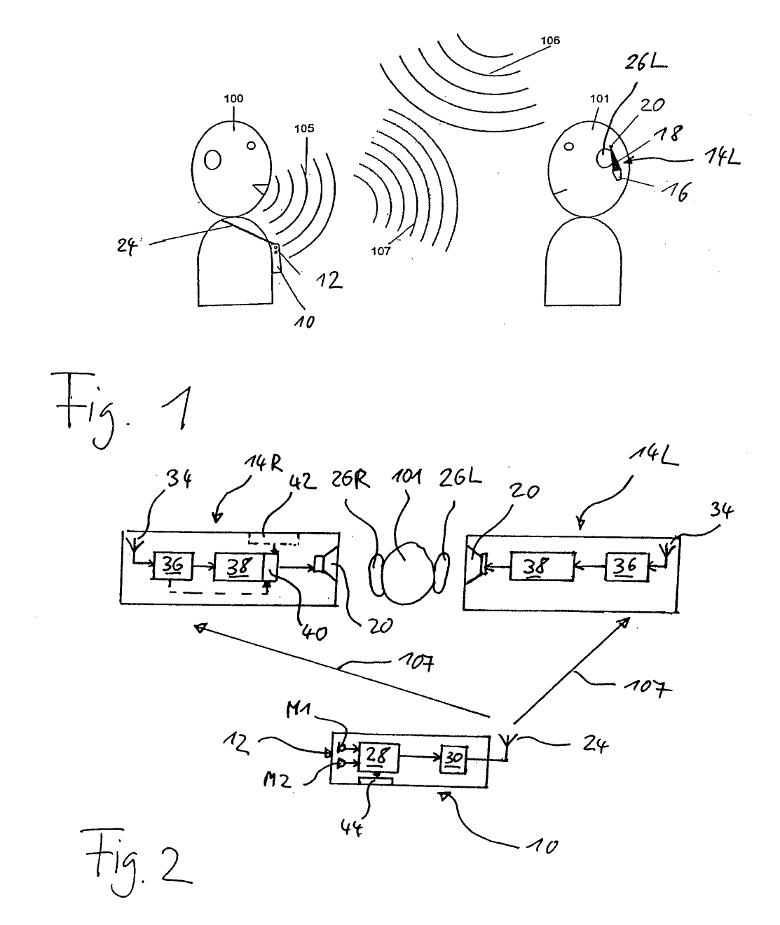

FIG. 1 schematically shows the use of a hearing assistance system comprising a transmission unit 10 having a microphone arrangement 12 with, preferably, two omni-directional microphones M1, M2, which are spaced apart, a right ear unit 14R and a left ear unit 14L, each comprising a receiver unit 16 and a hearing instrument 18 formed of a loudspeaker 20. The hearing instrument 18 and the receiver unit 16 may be connected by a mechanical/electrical interface 22 (for example, a so-called “audio shoe”) or they may be integrated into a common housing (as indicated by dashed lines in FIG. 4). The transmission unit 10 may be worn by a speaker 100 around his neck with a neck loop 24 acting as an antenna, the microphone arrangement 12 capturing the sound waves 105 carrying the speaker's voice. The right ear unit 14R is worn at or at least in part in the right ear 26R of a user 101, and the left unit 14L is worn at or at least in part in the left ear 26L of the user 101. The hearing aid 18 could be of any type, for example, BTE (Behind-The-Ear), ITE (In-The-Ear) or CIC (Completely-In-the-Canal). The speaker's voice 105 captured by the transmission unit 10 is transmitted as audio signals via a wireless audio link 107 to the right ear unit 14R and left ear unit 14L in order to be reproduced by the loudspeakers 20 to the ears 26R, 26L of the user 101. In addition to the voice 105 of the speaker 100, usually background/surrounding noise 106 will be present at the user's ears 26R, 26L.

An embodiment wherein the ear units 14R, 14L consist of a receiver unit 16 and a hearing instrument 18 is shown in more detail in FIG. 4 and will be described later.

According to the embodiment shown in FIG. 2, each of the ear units 14R, 14L comprises an antenna 34, a receiver 36 and an audio signal processing unit 38 for processing the audio signals received by the receiver 36. The processed audio signals are supplied as input to the loudspeaker 20. In the embodiment of FIG. 2, the receiver unit 16 is essentially formed by the antenna 34, the receiver 36 and the audio signal processing unit 38.

The transmission unit 10 comprises an audio signal processing unit 28 for processing the audio signals captured by the microphone arrangement 12 and a transmitter 30 for transmitting the processed audio signals via the antenna 26 via the audio link 107 to the ear units 14R, 14L, which are supplied, in the embodiment of FIG. 2, with the same audio signals via the audio link 107. However, if the microphone arrangement 12 is used as a stereo microphone, the audio signals could be transmitted as stereo signals via the audio link 107. Usually, the audio link 107 will be radio frequency link, such as an analog FM link. However, according to an alternative embodiment, the link 107 may be a digital audio link.

The system shown in FIG. 2 usually will be used by normal-hearing persons for communication purposes in noisy environments, such as by industrial workers, policemen, soldiers, pilots, call center agents, etc. The ear units 14R, 14L may be designed, according to the intended kind of use, as any appropriate kind of headset or earplug.

In order to improve the intelligibility of the audio signals received via the audio link 107, one of the two ear units 14R, 14L is provided with a signal delay unit 40 which serves to delay the audio signal supplied to the speaker 20 by 1 msec to 10 msec with regard to the audio signal supplied to the loudspeaker 20 of the other one of the ear units 14R, 14L (in the example shown in FIG. 2, the right ear unit 14R is provided with the signal delay unit 40).

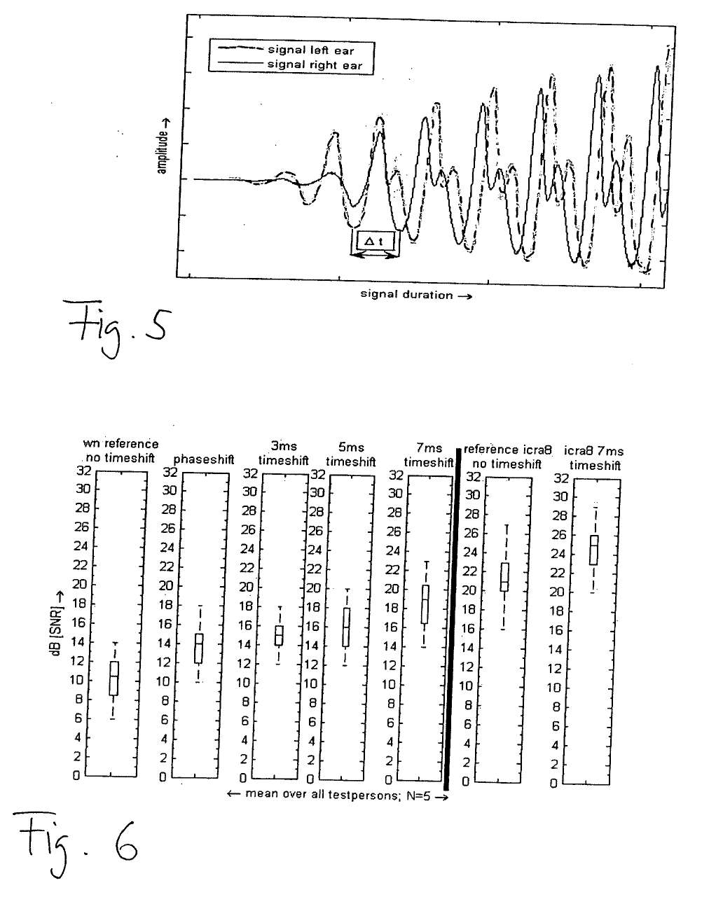

An example of such time delay At between the audio signal presented by the right ear unit 14R to the right ear 26R and the audio signal presented by the left ear unit 14L to the left ear 26L is illustrated in FIG. 5.

Preferably, the value of the time delay Δt will be variable in order to optimize the beneficial effect for different listening situations/auditory scenes. For example, for a quiet environment (i.e., no significant background noise) the time delay may be turned-off, i.e., the time delay Δt will be 0. To this end, the right ear unit 14R may comprise a control element 42 which can be manually operated by the user 101 in order to control the signal delay unit 40 in predefined steps, e.g., with a step size of 1 ms. Alternatively or in addition, the transmission unit 10 may be provided with a control element 44 which can be manually operated in order to transmit corresponding control commands for the time delay unit 40 to the right ear unit 14R via the wireless link 107, which in this case also serves as a data link. Alternatively or in addition, the right ear unit 14R may comprise a classifier unit for analyzing the audio signals received from the transmission unit 10 in order to determine the present auditory scene and to control the time delay unit 40 accordingly. As an alternative, such auditory scene analysis may be performed in the transmission unit 10 and corresponding control commands for the time delay unit 40 may be transmitted via the wireless link 107.

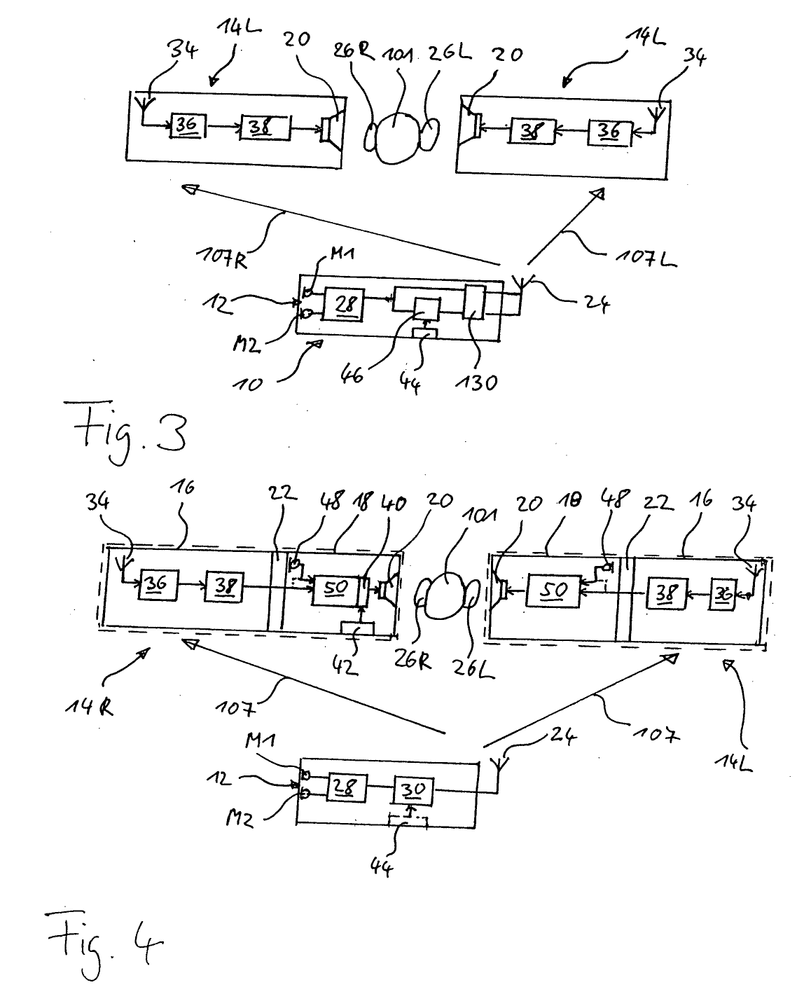

In FIG. 3, an embodiment is shown wherein the means for delaying the audio signals of one of the ear units 14R, 14L is not included in the ear units 14R, 14L but rather in the transmission unit 10. The audio signals provided by the audio signal processing unit 28 of the transmission unit 10 is split into two channels prior to being supplied to the transmitter 130, with one of the two channels being provided with a signal delay unit 46 in order to delay the signals of one of the two channels with regard to the other one. In the embodiment of FIG. 3 the transmitter 130 is a two-channel transmitter for supplying one of the ear units 14R, 14L with the delayed signal and the other one with the non-delayed signal. Hence, in this case the audio link 107R between the transmission unit 10 and the right ear unit 14R is separate from (i.e., orthogonal to) the audio link 107L between the transmission unit 10 and the right ear unit 14L. Also in this case the signal delay unit 46 may be controlled manually by a control element 44 and/or automatically according to auditory scene analysis performed in the audio signal processing unit 28.

In FIG. 4, an embodiment is shown wherein the ear units 14R, 14L each comprise a receiver unit 16 and a hearing instrument 18 having a microphone arrangement 48 (which may comprise a single microphone or two spaced apart microphones) for capturing audio signals at the user's respective ear 26R, 26L, a central unit 50 and the speaker 20. The central unit 50 serves for processing the audio signals received from the microphone arrangement 48 and from the receiver unit 16 prior to supplying it to the speaker 20 and for controlling operation of the hearing instrument 18. Depending on the type of hearing instrument 18, the output of the receiver unit 16 may be connected to a separate high impedance audio input of the hearing instrument 18, as shown in FIG. 4, or it may be connected to a low impedance audio input of the hearing instrument 18, which is connected in parallel to the microphone 48 (see dashed lines in FIG. 4). The system of FIG. 4 usually will be used by hearing impaired persons.

The ear units 14R, 14L usually will have at least three different modes of operation: a first mode in which only the audio signals provided by the receiver unit 16 are supplied to the speaker 20, a second mode in which only the audio signals captured by the microphone 48 are supplied to the speaker 20, and a third mode in which the audio signals provided by the receiver unit 16 and by the microphone 48 are both supplied to the speaker 20. The third mode usually will be used during most of the time. Usually the gain applied to the audio signals of the receiver unit 16 will be set such that for a given distance, e.g., 2 m, the level at the speaker 20 is higher, for example, by 10 dB, compared to the level of the same sound captured by the microphone 48, i.e., the so-called “FM advantage” may be set to, for example, 10 dB. According to an alternative embodiment, the FM advantage may be adapted according to the present auditory scene, as described for example in European Patent Application EP 1 691 574 A2.

According to the embodiment of FIG. 4, one of the ear units 14R, 14L is provided with a signal delay unit 40 in the hearing aid 18 in order to delay the audio signals from the transmission unit 10 at one of the user's ears 26R, 26L compared to the other one (in the example of FIG. 4 the right ear unit 14R comprises the signal delay unit 40). As shown in FIG. 4, the signal delay unit 40 may be provided at the output of the central unit 50 so that both the audio signals provided by the receiver unit 16 and the audio signals captured by the microphone 48 are delayed. According to an alternative embodiment, the signal delay unit 40 could be provided in such a manner that it acts only on the audio signals provided by the receiver unit 16, but not on the audio signals captured by the microphone 48.

In order to control the signal delay unit 40, the hearing aid 18 may be provided with a manual control element 42. Alternatively or in addition, the signal delay unit 40 may be controlled by the central unit 50 according to the result of an auditory scene analysis. In this case, auditory scene analysis may include analysis both of the audio signals from the receiver unit and from the microphone 48.

While various embodiments in accordance with the present invention have been shown and described, it is understood that the invention is not limited thereto, and is susceptible to numerous changes and modifications as known to those skilled in the art. Therefore, this invention is not limited to the details shown and described herein, and includes all such changes and modifications as encompassed by the scope of the appended claims.

1. A system for providing hearing assistance to a user, comprising:
an audio signal source,
a transmission unit for transmitting audio signals from the audio signal source via a wireless right ear audio link to a right ear unit to be worn at or at least in part in the user's right ear and comprising a receiver unit and means for stimulating the user's right ear according to the audio signals received from the transmission unit and via a wireless left ear audio link to a left ear unit to be worn at or at least in part in the user's left ear and comprising a receiver unit and means for stimulating the user's left ear according to the audio signals received from the transmission unit, and
delaying means for delaying the stimulation of one of the user's ears with the audio signals received from the transmission unit relative to the stimulation of the other one of the user's ears with the audio signals received from the transmission unit by 1 msec to 10 msec.

2. The system of claim 1, wherein the audio signal source is a microphone arrangement integrated into or connected to the transmission unit.

3. The system of claim 1, wherein the transmission unit comprises the delaying means.

4. The system of claim 3, wherein the transmission unit comprises means for splitting the audio signals from the audio signal source into two independent channels, wherein one of the channels is to be transmitted via the right ear audio link to the right ear unit and the other one of the channels is to be transmitted via the left ear audio link to the left ear unit, and the wherein the delaying means is adapted for delaying one of the two channels relative to the other prior to transmission.

5. The system of claim 1 2, wherein the delaying means is included in one of the right ear unit and the left ear unit.

6. The system of claim 5, wherein the transmission unit is adapted to transmit the audio signals from the audio signal source as a single channel via the right ear audio link to the right ear unit and via the left ear audio link to the left ear unit.

7. The system of claim 5, wherein the right ear unit and the left ear unit are adapted to provide as input to the stimulating means exclusively the audio signals received from the transmission unit.

8. The system of claim 5, wherein the right ear unit and the left ear unit each is a hearing instrument into which the receiver unit is integrated.

9. The system of of claim 5, wherein the right ear unit and the left ear unit each comprises a hearing instrument which is connected to the receiver unit for being supplied with the audio signals received by the receiver unit.

10. The system of claim 8, wherein each hearing instrument includes said stimulating means, a microphone arrangement for capturing audio signals and an audio signal processing unit for processing the audio signals captured by the microphone arrangement of the hearing instrument and/or the audio signals received by the receiver unit.

11. The system of claim 8, wherein the delaying means is included in the hearing instrument.

12. The system of claim 11, wherein the delaying means is adapted to delay the audio signals processed in the hearing instrument prior to being supplied as input to the stimulating means.

13. The system of claim 5, wherein the delaying means is included in the receiver unit.

14. The system of claim 1, wherein a means for analyzing at least one of the audio signals of the transmission unit and the acoustic background noise is provided and wherein the delaying means is controlled automatically according to the result of the analysis.

15. The system of claim 1, wherein a means for manually controlling the delaying means is provided.

16. The system of claim 1, wherein the right ear unit and the left ear unit are part of a headset or are designed as earplugs.

17. A method of providing hearing assistance to a user, comprising:
generating audio signals by an audio signal source and transmitting said audio signals by a transmission unit via a wireless right ear audio link to a right ear unit which is worn at or at least in part in the user's right ear and comprises means for stimulating the user's right ear and via a wireless left ear audio link to a left ear unit which is worn at or at least in part in the user's left ear and comprises means for stimulating the user's left ear,
stimulating the user's ears by the stimulating means according to the audio signals received from the transmission unit,
wherein the stimulation of one of the user's ears with the audio signals received from the transmission unit relative to the stimulation of the other one of the user's ears with the audio signals received from the transmission unit is delayed by 1 msec to 10 msec.

18. The method of claim 17, wherein the stimulation delay is manually controlled by the user.

19. The method of claim 17, wherein the stimulation delay is automatically controlled according to the result of an auditory scene classification.

20. The method of claim 19, wherein the auditory scene classification is performed based on at least one of the audio signals generated by the audio signal source and audio signals captured at the user's ear by at least one of the right ear unit and the left ear unit.

21. The method of claim 17, wherein audio signals are captured by a microphone arrangement of each of the right ear unit and the left ear unit and are mixed with the audio signals received from the transmission unit prior to being supplied to the stimulation means.
